(19) United States
(12) Patent Application Publication
(10) Pub. No.: US 2019/0353241 A1
(43) Pub. Date: Nov. 21, 2019

(54) SHIFT CONTROL APPARATUS FOR ELECTRONIC SHIFT SYSTEM

(71) Applicants: Hyundai Motor Company, Seoul (KR); Kia Motors Corporation, Seoul (KR)

(72) Inventors: Yong Ik KIM, Hanam-si (KR); Chang Hyun Lee, Seoul (KR); Bum Jun Kim, Bucheon-si (KR)

(73) Assignees: Hyundai Motor Company, Seoul (KR); Kia Motors Corporation, Seoul (KR)

(21) Appl. No.: 16/169,832

(22) Filed: Oct. 24, 2018

(30) Foreign Application Priority Data
May 16, 2018 (KR) 10-2018-0056215

(51) Int. Cl. F16H 59/12

(52) U.S. Cl. CPC F16H 59/12; F16H 2059/081

(57) ABSTRACT

A shift control apparatus configured for an electronic shift system, may include shift dial disposed on a main housing to be able to turn in a first direction or a second direction and having a permanent magnet; a main PCB disposed on the main housing opposite the permanent magnet, and recognizing gear stages and outputting signals for the recognized gear stages to a transmission control unit in accordance with a change in position of the permanent magnet when the shift dial is turned; a shift button being movable upwards and downwards with respect to the shift dial; and a sub PCB coupled to the shift dial and outputting a gear stage signal, which is generated when the shift button is operated, to the transmission control unit.

### CROSS REFERENCE TO RELATED APPLICATION

The present application claims priority to Korean Patent Application No. 10-2018-0056215, filed May 16, 2018, the entire contents of which is incorporated herein for all purposes by this reference.

### BACKGROUND OF THE INVENTION

### Field of the Invention

The present invention relates to a shift control apparatus for an electronic shift system and, more particularly, to a shift control apparatus for an electronic shift system, the apparatus being configured such that an R-stage, an N-stage, and a D-stage are selected when a dial is turned and a P-stage is selected when a shift button is pressed.

### Description of Related Art

In general, in vehicles provided with an automatic transmission, gears of desired shift ranges are automatically selected by controlling hydraulic pressure within a shift range set for the speed of the vehicles.

An automatic transmission generates gear ratios using a hydraulic circuit, a planetary gear set, and friction members to shift and these components are controlled by a Transmission Control Unit (TCU).

A shift-by-wire (hereafter, referred to as SBW) system, which is an electronic shift system for a vehicle, has no mechanical connection structure such as a cable between a transmission and a shift lever, unlike existing mechanical shift systems. In the SBW system, when a sensor value generated by operation of an electronic shift lever, a button, or a dial is transmitted to the TCU, a solenoid or an electric motor is operated by an electronic signal from the TCU and hydraulic pressure is applied or not applied to the hydraulic circuit for each gear stage by the operation of the solenoid or the electric motor, electronically controlling shifting.

Accordingly, an automatic transmission based on SBW transmits the intention of shifting of a driver to the TCU, using an electrical signal, when the electronic shift lever, the button, or the dial is operated, easily shifting to a forward range (D), a rearward range (R), a neutral range (N), and a park range (P). Furthermore, the shift lever may be manufactured in a small size, so a wide space may be secured between the driver's seat and the passenger's seat.

As a method of shifting using an electronic shift system, largely, there is a lever type using a lever, a button type using a button, and a dial type using a dial.

In a dial-type electronic shift control apparatus of the related art, a P-stage, an R-stage, an N-stage, and a D-stage are selected when a dial is turned clockwise, that is, the R-stage is positioned between the P-stage and the N-stage. Accordingly, a driver may turn the dial to the P-stage due to unskillful operation when shifting to the R-stage from the D-stage, and in the instant case, there is a high possibility of an accident caused by sudden stop of the vehicle.

Furthermore, as described above, since the R-stage is positioned between the P-stage and the N-stage, a driver has to concentrate to avoid turning the dial to the P-stage when shifting from the D-stage to the R-stage, so that the drive becomes fatigued more rapidly due to shifting.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a shift control apparatus configured for an electronic shift system, the apparatus configured such that an R-stage, an N-stage, and a D-stage are selected when a dial is turned and a P-stage is selected when a shift button is pressed, to prevent mis-operation when a driver shifts to the D-stage from the R-stage or to the R-stage from the D-stage, and improve convenience of shifting.

In accordance with an aspect of the present invention, there is provided a shift control apparatus configured for an electronic shift system, the shift control apparatus including: a shift dial disposed on a main housing to be configured to turn in a first direction or a second direction and having a permanent magnet; a main PCB disposed on the main housing opposite to the permanent magnet, and recognizing gear stages and outputting signals for the recognized gear stages to a transmission control device in accordance with a change in position of the permanent magnet when the shift dial is turned; a shift button being movable upwards and downwards with respect to the shift dial; and a sub PCB coupled to the shift dial and outputting a gear stage signal, which is generated when the shift button is operated, to the transmission control device.

The shift control apparatus further includes an elastic pad disposed on the sub PCB and having contact points with the shift button on the contact points, in which when the shift button is operated and the contact points of the elastic pad come in contact with the sub PCB, the sub PCB outputs a gear stage signal to the transmission control device.

The sub PCB outputs a P-stage signal to the transmission control device when the shift button is pressed and the contact points of the elastic pad come in contact with the sub PCB, and the main PCB outputs a gear stage signal for any one of an R-stage, an N-stage, and a D-stage to the transmission control device in accordance with a change in position of the permanent magnet when the shift dial is turned in the first direction or the second direction thereof.

The shift control apparatus further includes a light combined with the shift button to be controlled to be turned on or off by the sub PCB. The light is turned on when the P-stage is selected and is turned off when the other gear stages are selected from the P-stage.

The shift dial includes: a knob housing combined with the main housing to be configured to turn in the first direction or the second direction and having the permanent magnet opposite to the main PCB; and a dial knob combined with the knob housing to turn together.

The shift control apparatus further includes a detent combined with the main housing and the shift dial in contact with each other to click when the shift dial is turned.

The detent includes: a detent boss disposed at the shift dial; a detent pin combined with the detent boss to be configured to protrude in the radial direction of the shift dial; a detent block fixed to the main housing, being in contact with the front end portion of the detent pin, and having a grooved portion for shifting on the surface being in contact with the detent pin; and a spring elastically supporting the detent pin to keep the front end portion of the detent pin in contact with the grooved portion.

The grooved portion is formed in a shape in which ridges and grooves are continuously connected, a left groove and a right groove having the same depth are formed at the left and right sides of a middle ridge at the center, the left groove and the right groove are connected to a left ridge and a right ridge through a left slope and a right slope, respectively, and the peak of the middle ridge is positioned between the left slope and the right slope.

An R-stage point is positioned on the left slope, a D-stage point is positioned on the right slope, an Nr-stage point and an Nd-stage point are positioned at the left groove and the right groove, respectively, and the Nr-stage point and the Nd-stage point are all null stages and N-stages.

When the detent pin is moved from the Nr-stage point to the Nd-stage point with the R-stage currently selected, a PCB outputs an N-stage signal as a final gear stage signal; when the detent pin is moved from the Nr-stage point to the Nd-stage point and is further moved to the Nr-stage point with the R-stage currently selected, the PCB outputs an R-stage signal as the final gear stage signal; and when the detent pin is moved to the R-stage point or moved to the Nr-stage point over the R-stage point with the R-stage currently selected, the PCB outputs the R-stage signal as the final gear stage signal.

When the detent pin is moved from the Nd-stage point to the Nr-stage point with the N-stage currently selected, a PCB outputs an R-stage signal as a final gear stage signal; when the detent pin is moved from the Nr-stage point to the Nd-stage point with the N-stage currently selected, the PCB outputs a D-stage signal as the final gear stage signal; when the detent pin is moved from the Nr-stage point to the R-stage point with the N-stage currently selected, the PCB outputs the R-stage signal as the final gear stage signal; when the detent pin is moved from the Nd-stage point to the D-stage point with the N-stage currently selected, the PCB outputs the D-stage signal as the final gear stage signal; and when the detent pin is not moved and the shift button is pressed with the N-stage currently selected, the PCB outputs a P-stage signal as the final gear stage signal.

When the detent pin is moved from the Nd-stage point to the Nr-stage point with the D-stage currently selected, a PCB outputs an N-stage signal as a final gear stage signal; when the detent pin is moved from the Nd-stage point to the Nr-stage point and is further moved to the Nd-stage point with the D-stage currently selected, the PCB outputs a D-stage signal as the final gear stage signal; and when the detent pin is moved to the D-stage point or moved to the Nd-stage point over the D-stage point with the D-stage currently selected, the PCB outputs the D-stage signal as the final gear stage signal.

When the detent pin is moved from the Nr-stage point to the Nd-stage point with the P-stage currently selected, a PCB outputs a D-stage signal as a final gear stage signal; and when the detent pin is moved from the Nd-stage point to the Nr-stage point with the P-stage currently selected, the PCB outputs an R-stage signal as the final gear stage signal.

The detent includes: a detent boss disposed on the main housing; a detent pin combined with the detent boss to be configured to protrude toward the shift dial; a gear plate combined with the shift dial to rotate together and having teeth formed on the external edge portion in contact with the front end portion of the detent pin; and a spring elastically supporting the detent pin to keep the front end portion of the detent pin in contact with the teeth.

When the shift dial is turned one click in the first direction with an R-stage currently selected, a PCB outputs an N-stage signal as a final gear stage signal; when the shift dial is turned one or more clicks in the first direction with the R-stage currently selected, the PCB outputs a D-stage signal as the final gear stage signal; and when the shift dial is turned one or more clicks in the second direction with the R-stage currently selected, the PCB outputs an R-stage signal as the final gear stage signal.

When the shift dial is turned one or more clicks in the first direction with an N-stage currently selected, a PCB outputs a D-stage signal as a final gear stage signal; when the shift dial is turned one or more clicks in the second direction with the N-stage currently selected, the PCB outputs an R-stage signal as the final gear stage signal; and when the shift dial is not turned and the shift button is pressed with the N-stage currently selected, the PCB outputs a P-stage signal as the final gear stage signal.

When the shift dial is turned one click in the second direction with a D-stage currently selected, a PCB outputs an N-stage signal as a final gear stage signal; when the shift dial is turned two or more clicks in the second direction with the D-stage currently selected, the PCB outputs an R-stage signal as the final gear stage signal; and when the shift dial is turned one or more clicks in the first direction with the D-stage currently selected, the PCB outputs a D-stage signal as the final gear stage signal.

When the shift dial is turned one click in the first direction or the second direction with a P-stage currently selected, a PCB outputs an N-stage signal as a final gear stage signal; when the shift dial is turned two or more clicks in the first direction with the P-stage currently selected, the PCB outputs a D-stage signal as the final gear stage signal; and when the shift dial is turned two or more clicks in the second direction with the P-stage currently selected, the PCB outputs an R-stage signal as the final gear stage signal.

In accordance with an aspect of the present invention, there is provided a shift control apparatus configured for an electronic shift system, in which a P-stage is selected by pressing a shift button; any one of an R-stage, an N-stage, and a D-stage is selected by turning a shift dial; the R-stage is positioned at the end portion in a first direction, the D-stage is positioned at the end portion in a second direction, and a null-stage is positioned between the R-stage and the D-stage, when the shift dial is turned; the shift dial is self-returned to the null-stage by a spring force when the shift dial is turned from the null-stage to the R-stage and then released; and the shift dial is self-returned to the null-stage by the spring force when the shift dial is turned from the null-stage to the D-stage and then released.

The null-stage is divided into an Nr-stage and an Nd-stage; and the Nr-stage is positioned at a side of the R-stage, the Nd-stage is positioned at a side of the Nr-stage, and the D-stage is positioned at a side of the Nd-stage, when the shift dial is turned from the R-stage to the D-stage.

The shift dial is self-returned to an Nr-stage by a spring force when the shift dial is turned from the Nr-stage to the R-stage and then released; and the shift dial is self-returned to an Nd-stage by the spring force when the shift dial is turned from the Nd-stage to the D-stage and then released.

According to the exemplary embodiment of the present invention, the R-stage, N-stage, and D-stage are selected by turning the shift dial and the P-stage is selected by pressing the shift button. Furthermore, the R-stage is positioned at the counterclockwise end portion of the shift dial and the D-stage is positioned at the clockwise end. Accordingly, it is possible to prevent mis-operation when shifting from the R-stage to the D-stage or from the D-stage to the R-stage, using the shift dial, and, it is possible to considerably improve the convenience of shifting.

Furthermore, since the shift button for selecting the P-stage is separate from the shift dial for selecting other gear stages, it is possible to more safely engage the P-stage.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a shift control apparatus configured for an electronic shift system according to an exemplary embodiment of the present invention;

FIG. 2, FIG. 3 and FIG. 4 are views illustrating a detent according to various exemplary embodiments of the present invention;

FIG. 5 is a table showing a shifting pattern which is determined by the detent according to the various exemplary embodiments;

FIG. 6, FIG. 7, and FIG. 8 are views illustrating a detent according to various exemplary embodiments of the present invention; and

FIG. 9 is a table showing a shifting pattern which is determined by the detent according to the various exemplary embodiments.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in portion by the intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

A shift control apparatus configured for an electronic shift system according to exemplary embodiments of the present invention is described hereafter in detail with reference to the accompanying drawings.

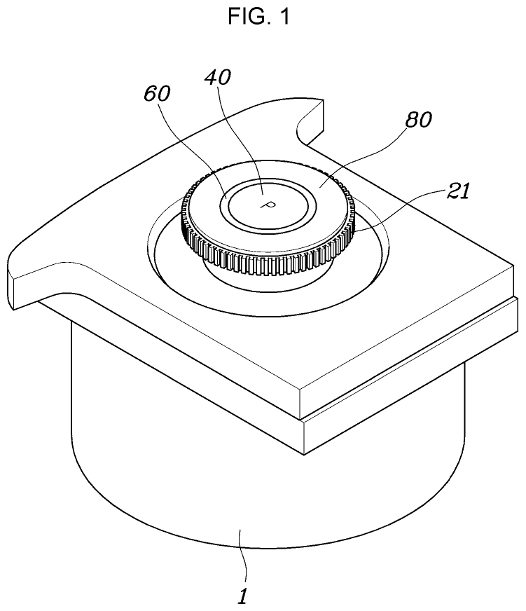

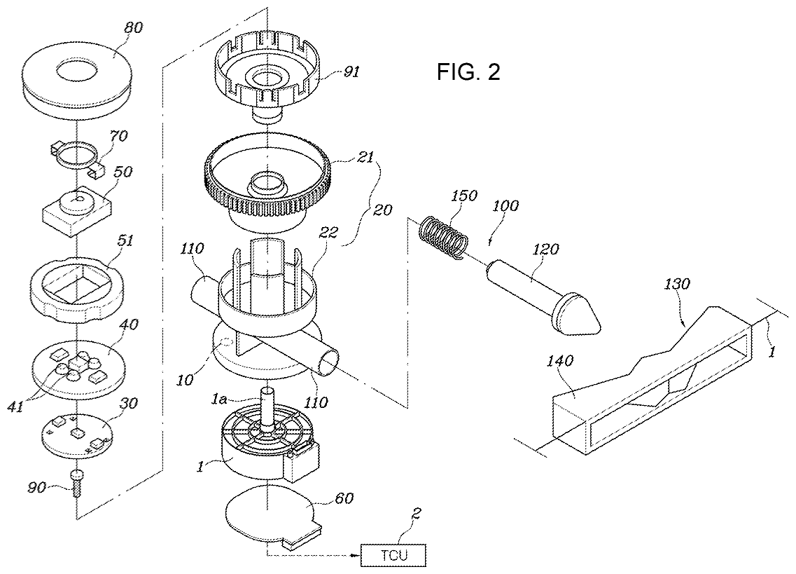

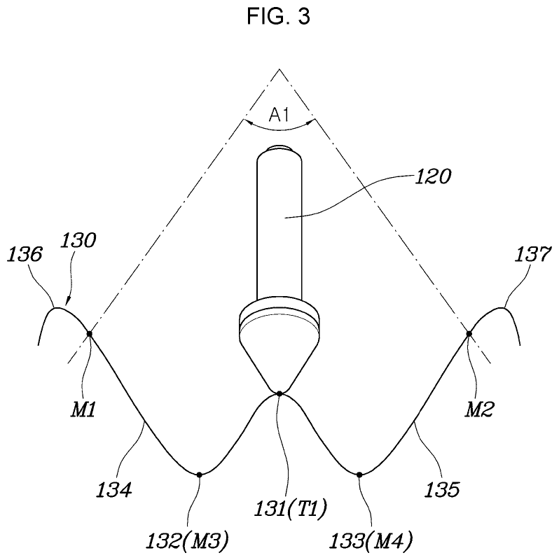

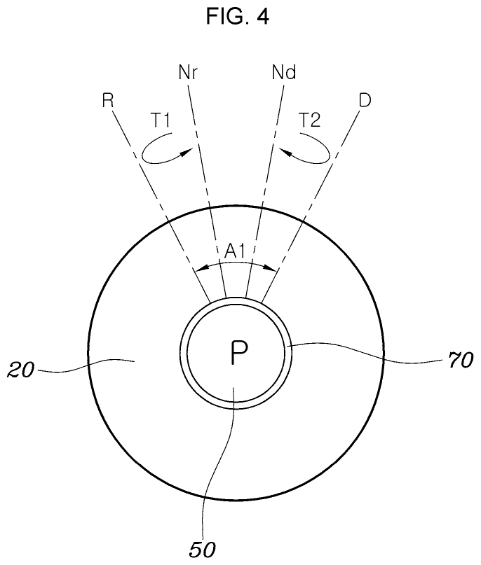

A shift control apparatus configured for an electronic shift system according to an exemplary embodiment of the present invention, as shown in FIG. 1 and FIG. 2, includes: a shift dial 20 disposed on a main housing 1 to be configured to turn clockwise or counterclockwise and having a permanent magnet 10 on the bottom; a main Printed Circuit Board (PCB) 60 disposed on the main housing 1 opposite to the permanent magnet 10, and recognizing gear stages (R-, N-, and D-stages) and outputting signals for the recognized gear stages to a Transmission Control Unit (TCU) 2 in accordance with a change in the position of the permanent magnet 10 when the shift dial 20 is turned; a shift button 50 being movable upwards and downwards with respect to the shift dial 20; and a sub PCB 30 coupled to the shift dial 20 and outputting a gear stage signal (P-stage signal), which is generated when the shift button 50 is operated, to the TCU 2.

The apparatus further includes an elastic pad 40 disposed on the sub PCB 30 and having contact points 41 with the shift button 50 on the contact points 41. When the shift button 50 is operated and the contact points 41 of the elastic pad 40 come in contact with the sub PCB 30, the sub PCB 30 outputs a gear stage signal (P-stage signal) to the TCU.

Clockwise rotation of the shift dial 20 means rotation in a first direction and counterclockwise rotation of the shift dial 20 means rotation in a second direction.

The main housing 1 is disposed on a console close to a driver and the shift dial 20 and the shift button 50 protrude upward through the top portion of the main housing 1 so that the driver can operate them.

The shift dial 20 is rotatably disposed on a main housing shaft 1a on the main housing 1 and a knob bracket 91 is disposed in an upwardly open space of the shift dial 20. The knob bracket 91 is fixed to the main housing shaft 1a of the main housing 1 by a fastener 90 such as a screw or a bolt.

The knob bracket 91 has a space 95 open upward, the sub PCB 30 is fixed in the upwardly open space 95 of the knob bracket 91, the elastic pad 40 made of rubber and having the contact points 41 is accommodated on the sub PCB 30, and the shift button 50 is disposed on the elastic pad 40. The shift button 50 is guided up and down by a retainer 51.

Since the shift button 50 may be moved upwards and down with respect to the shift dial 20, when a driver presses down the shift button 50, the elastic pad 40 is pressed and the contact points 41 come in contact with the sub PCB 30. Furthermore, when the pressed shift button 50 is released, the elastic pad 40 made of rubber returns and moves up and returns the shift button 50 that has moved down to the initial position. Furthermore, when the shift button 50 is moved upwards. The contact points 41 come off the sub PCB 30.

When the shift button 50 is moved down and the contact points 41 come in contact with the sub PCB 30, the sub PCB 30 outputs a P-stage signal to the TCU 2.

The main PCB 60 is fixed to the main housing 1 to face the permanent magnet 10 with a predetermined gap therebetween.

When the position of the permanent magnet 10 is changed by a rotation of the shift dial 20, the main PCB 60 outputs a switch signal for the gear stage selected on the basis of a current value corresponding to changed magnetic flux to the TCU 2, the TCU 2 controls the solenoid or the electric motor of the transmission on the basis of a control signal from the main PCB 60, and hydraulic pressure is applied or not applied to the hydraulic circuit for each gear stage by operation of the solenoid or the electric motor, whereby electronic shift control is performed.

According to an exemplary embodiment of the present invention, any one of the R-stage, N-stage, and D-stage is selected when the dial 20 is turned clockwise or counterclockwise, and the P-stage is selected when the shift button 50 is pressed. Accordingly, it is possible to prevent mis-operation when shifting to the D-stage from the R-stage or to the R-stage from the D-stage by turning the shift dial 20 and, it is also possible to improve the convenience of shifting using the shift dial 20.

Furthermore, the apparatus according to an exemplary embodiment of the present invention further includes a light 70 coupled to the shift button 50 and electrically connected to the sub PCB 30 to be controlled to be turned on or off by the sub PCB 30. That is, the light 70 is turned on when the P-stage is selected and is turned off in shifting to other gear stages (R-, N-, and D-stages) from the P-stage.

The light 70 is formed in a annular shape and light is exposed over the shift button 50 when the light 70 is turned on, but the position and shape of the light 70 may be changed in various ways.

The shift button 50 is covered by a button cover 80 and the button cover 80 is separably combined with the shift dial 20. Accordingly, the shift button 50 is prevented from being separated upward by the button cover 80.

The shift dial 20 includes a dial knob 21 and a knob housing 22.

The knob housing 22 is fitted on the main housing shaft 1a of the main housing 1 to be rotatable in the first direction (clockwise) or the second direction (counterclockwise) and the permanent magnet 10 facing the main PCB 60 is combined with the knob housing 22.

The dial knob 21 is combined with the knob housing 22, so it is rotated with the knob housing 22.

The knob bracket 91 is disposed in the upwardly open space of the dial knob 21 and fixed to the main housing 1 by the fastener 90, the sub PCB 30, the elastic pad 40, the shift button 50, and the retainer 51 are disposed in the open space of the knob bracket 91, the light 70 and the button cover 80 are coupled to the top portion of the shift button 50, the knob housing 22 combined with the dial knob 21 is combined with the main housing 1 to be rotatable clockwise or counterclockwise, the permanent magnet 10 is combined with the knob housing 22, and the main PCB 60 is combined with the main housing 1 opposite to the permanent magnet 10.

The apparatus according to an exemplary embodiment of the present invention further includes a detent 100 or 200 combined with the main housing 1 and the shift dial 20 in contact with each other to click so that a driver can feel shifting when turning the shift dial 20.

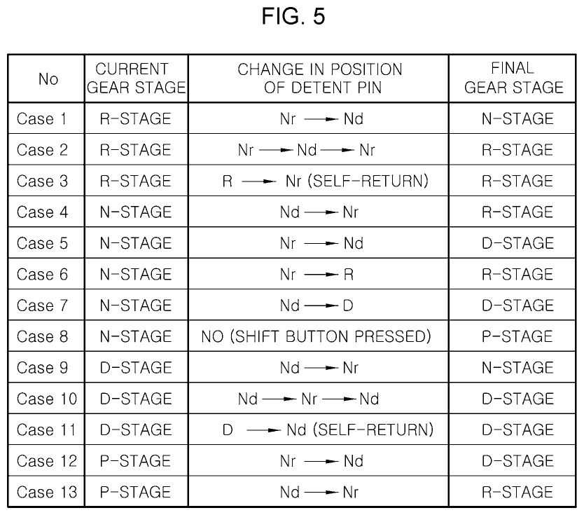

FIG. 2 and FIG. 3 show a detent 100 according to various exemplary embodiments, FIG. 4 shows the operation process of the shift dial 20 when the detent 100 according to the various exemplary embodiments is provided, and FIG. 5 is a table showing a shifting pattern which is determined by the detent 100 according to the various exemplary embodiments.

The detent 100 according to the various exemplary embodiments of the present invention includes: a detent boss 110 radially protruding from the shift dial 20; a detent pin 120 combined with the detent boss 110 to be configured to protrude in the radial direction of the shift dial 20; a detent block 140 fixed to the main housing 1, being in contact with the front end portion of the detent pin 120, and having a grooved portion 130 for shifting on the surface being in contact with the detent pin 120; and a spring 150 elastically supporting the detent pin 120 to keep the front end portion of the detent pin 120 in contact with the grooved portion 130.

The detent boss 110 radially protrudes from the knob housing 22 of the shift dial 20, one or two detent bosses may be provided, and when two detent bosses are provided, they are disposed with an interval of 180 degrees.

The grooved portion 130 formed at the detent block 140 has ridges and grooves continuously formed. A left groove 132 and a right groove 133 having the same depth are formed at the left and right sides of a middle ridge 131 at the center and are connected to a left ridge 136 and a right ridge 137 through a left slope 134 and a right slope 135, respectively. The peak T1 of the middle ridge 131 is positioned between the left slope 134 and the right slope 135.

Accordingly, the detent 100 according to the various exemplary embodiments has an R-stage point M1 on the left slope 134, a D-stage point M2 on the right slope 135, and an Nr-stage point M3 and an Nd-stage point M4 at the left groove 132 and the right groove 133, respectively. The Nr-stage point M3 and Nd-stage point M4 are all null stages and N-stages.

The front end portion of the detent pin 120 is moved between the R-stage point M1 and the D-stage point M2 (within an angle A1) by a rotation of the shift dial 20, and two null-stage points M3 and M4 exist between the R-stage point m1 and the D-stage point m2.

The detent 100 according to the various exemplary embodiments of the present invention has the shifting pattern shown in FIG. 5 when the shift dial 20 is turned and the shift button 50 is pressed.

In Case 1 to Case 3, the currently selected stage is the R-stage. In the present state, when the detent pin 120 is moved from the Nr-stage point M3 to the Nd-stage point M4 by a rotation of the shift dial 20, the main PCB 60 outputs an N-stage signal as a final gear stage signal. When the detent pin 120 is moved from the Nr-stage point M3 to the Nd-stage point M4 and is further moved to the Nr-stage point M3, the main PCB 60 outputs an R-stage signal as the final gear stage signal. When the detent pin 120 is moved from the Nr-stage point M3 to the R-stage point M1 or moved back to the Nr-stage point M3 over the R-stage point M1, the main PCB 60 outputs the R-stage signal as the final gear stage signal.

In Case 4 to Case 8, the currently selected gear stage is the N-stage. In the present state, when the detent pin 120 is moved from the Nd-stage point M4 to the Nr-stage point M3, the main PCB 60 outputs the R-stage signal as the final gear stage signal, when the detent pin 120 is moved from the Nr-stage point M3 to the Nd-stage point M4, the main PCB 60 outputs a D-stage signal as the final gear stage signal, when the detent pin 120 is moved from the Nr-stage point M3 to the R-stage point M1, the main PCB 60 outputs the R-stage signal as the final gear stage signal, when the detent pin 120 is moved from the Nd-stage point M4 to the D-stage point M2, the main PCB 60 outputs the D-stage signal as the final gear stage signal, and when the detent pin 120 is not moved and the shift button 50 is pressed, the main PCB 60 outputs a P-stage signal as the final gear stage signal.

In Case 9 to Case 11, the currently selected gear stage is the D-stage. In the present state, when the detent pin 120 is moved from the Nd-stage point M4 to the Nr-stage point M3, the main PCB 60 outputs the N-stage signal as the final gear stage signal. When the detent pin 120 is moved from the Nd-stage point M4 to the Nr-stage point M3 and then moved to the Nd-stage point M4, the main PCB 60 outputs the D-stage signal as the final gear stage signal. When the detent pin 120 is moved from the Nd-stage point M4 to the D-stage point M2 or is moved back to the Nd-stage point M4 over the D-stage point M2, the main PCB 60 outputs the D-stage signal as the final gear stage signal.

In Case 12 to Case 13, the currently selected gear stage is the P-stage. In the present state, when the detent pin 120 is moved from the Nr-stage point m3 to the Nd-stage point M4, the main PCB 60 outputs the D-stage signal as the final gear stage signal, and when the detent pin 120 is moved from the Nd-stage point M4 to the Nr-stage point M3, the main PCB 60 outputs the R-stage signal as the final gear stage signal.

Case 3 is a situation in which the detent pin 120 is self-returned to the Nr-stage point M3 over the R-stage point M1 by the left slope 134 and the return force of the spring 150 (see the arrow T1 in FIG. 4). Case 11 is a situation in which the detent pin 120 is self-returned to the Nd-stage point M4 over the D-stage point M2 by the right slope 135 and the return force of the spring 150 (see the arrow T2 in FIG. 4).

Accordingly, when the shift dial 20 is turned, the detent pin 120 self-returns to the Nr-stage point M3 over the R-stage point M1, self-returns to the Nd-stage point M4 over the D-stage point M2, or moves between the Nr-stage point M3 and the Nd-stage point M4, whereby clicking is generated. Accordingly, according to an exemplary embodiment of the present invention, a driver can easily feel shifting when shifting by turning the shift dial 20.

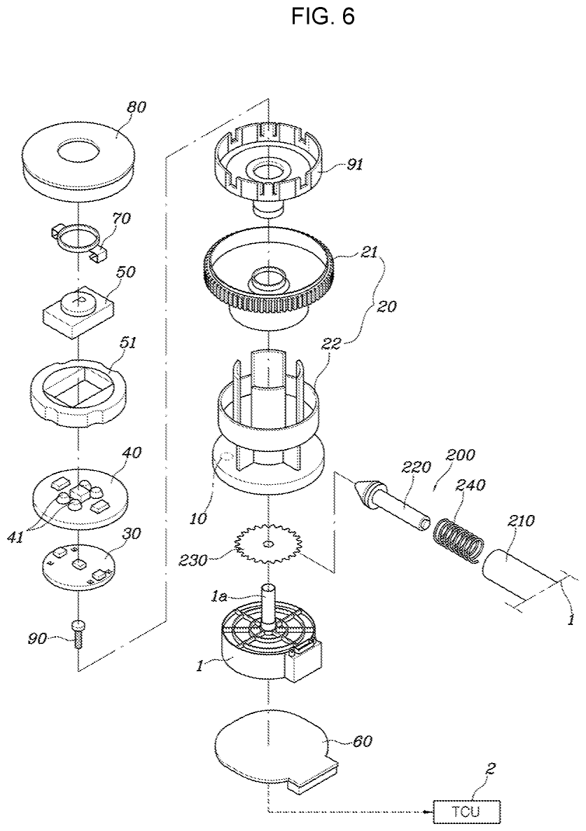

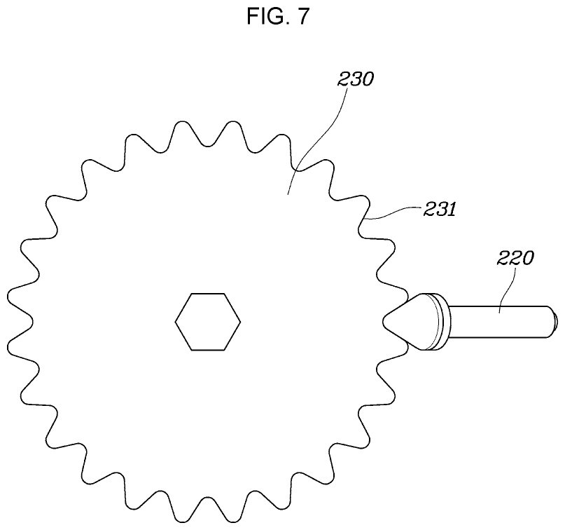

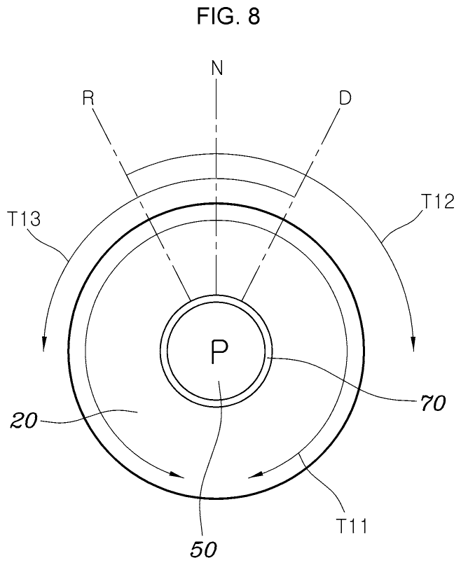

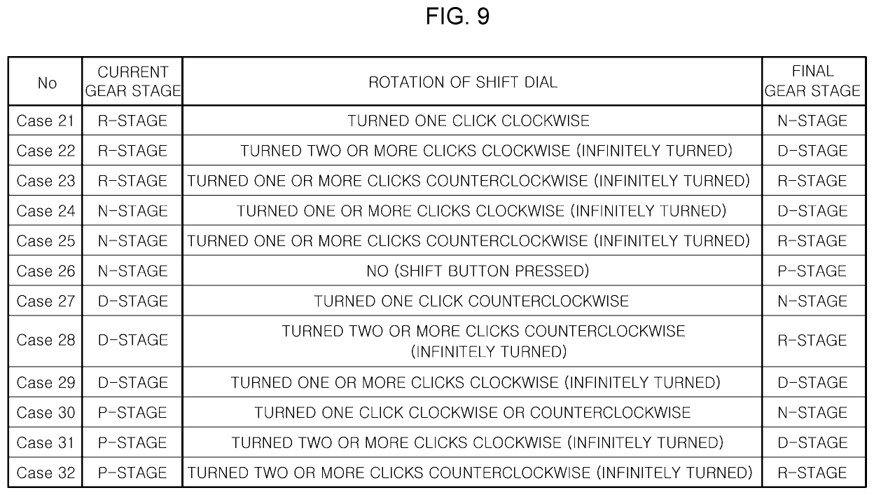

FIG. 6 and FIG. 7 show a detent 200 according to various exemplary embodiments, FIG. 8 shows the operation process of the shift dial 20 when the detent 200 according to the various exemplary embodiments is provided, and FIG. 9 is a table showing a shifting pattern which is determined by the detent 200 according to the various exemplary embodiments.

The detent 200 according to the various exemplary embodiments of the present invention includes: a detent boss 210 disposed on the main housing 1 and protruding toward the shift dial 20; a detent pin 220 combined with the detent boss 120 to be configured to protrude toward the shift dial 20; a gear plate 230 coupled to the bottom portion of the shift dial 20 to rotate with the shift dial 20 and having teeth 231 formed on the external edge portion in contact with the front end portion of the detent pin 220; and a spring 240 elastically supporting the detent pin 220 to keep the front end portion of the detent pin 220 in contact with the teeth 231.

The detent 200 according to the various exemplary embodiments of the present invention has the shifting pattern shown in FIG. 9 when the shift dial 20 is turned and the shift button 50 is pressed.

In Case 21 to Case 23, the currently selected gear stage is the R-stage. In the present state, when the dial 20 is turned one click clockwise (in the first direction), the main PCB 60 outputs an N-stage signal as the final gear stage signal, when the shift dial 20 is turned two or more clicks clockwise (in the first direction), the main PCB 60 outputs the D-stage signal as the final gear stage signal, and when the shift dial 20 is turned one or more clicks counterclockwise (in the second direction), the main PCB 60 outputs the R-stage signal as the final gear stage signal.

In Case 24 to Case 26, the currently selected gear stage is the N-stage. In the present state, when the shift dial 20 is turned one or more clicks clockwise, the main PCB 60 outputs the D-stage signal as the final gear stage signal, when the shift dial 20 is turned one or more clicks counterclockwise, the main PCB 60 outputs the R-stage signal as the final gear stage signal, and when the shift dial 20 is not turned and the shift button 50 is pressed, the main PCB 60 outputs the P-stage signal as the final gear stage signal.

In Case 27 to Case 29, the currently selected gear stage is the D-stage. In the present state, when the shift dial 20 is turned one click counterclockwise, the main PCB 60 outputs the N-stage signal as the final gear stage signal, when the shift dial 20 is turned two or more clicks counterclockwise, the main PCB 60 outputs the R-stage signal as the final gear stage signal, and when the shift dial 20 is turned one or more clicks clockwise, the main PCB 60 outputs the D-stage signal as the final gear stage signal.

In Case 30 to Case 33, the currently selected gear stage is the P-stage. In the present state, when the dial 20 is turned one click clockwise or counterclockwise, the main PCB 60 outputs the N-stage signal as the final gear stage signal, when the shift dial 20 is turned two or more clicks clockwise, the main PCB 60 outputs the D-stage signal as the final gear stage signal, and when the shift dial 20 is turned two or more clicks counterclockwise, the main PCB 60 outputs the R-stage signal as the final gear stage signal.

When the detent 200 according to the various exemplary embodiments of the present invention is provided, the shift dial 20 is infinitely turned clockwise or counterclockwise (see the arrow T11 in FIG. 8). The shift dial 20 is infinitely turned toward the D-stage in Case 22, Case 24, Case 29, and Case 31 (see the arrow T12 in FIG. 8). Furthermore, the shift dial 20 is infinitely turned toward the R-stage in Case 23, Case 25, Case 28, and Case 32 (see the arrow T13 in FIG. 8).

According to the exemplary embodiment of the present invention described above, the R-stage, N-stage, and D-stage are selected by turning the shift dial 20 and the P-stage is selected by pressing the shift button 50. Furthermore, the R-stage is positioned at the counterclockwise end portion of the shift dial 20 and the D-stage is positioned at the clockwise end. Accordingly, it is possible to prevent mis-operation when shifting from the R-stage to the D-stage or from the D-stage to the R-stage, using the shift dial 20, and It is possible to improve the convenience of shifting.

Furthermore, since the shift button 50 for selecting the P-stage is separate from the shift dial 20 for selecting other gear stages in an exemplary embodiment of the present invention, it is possible to more safely engage the P-stage.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shift control apparatus for an electronic shift system, the shift control apparatus comprising:
a shift dial disposed on a main housing to be configured to turn in a first direction or a second direction and having a permanent magnet;
a main PCB disposed on the main housing opposite to the permanent magnet with respect to the main housing, and recognizing gear stages and outputting signals for the recognized gear stages to a transmission control device in accordance with a change in position of the permanent magnet when the shift dial is turned;
a shift button slidably mounted on the shift dial and movable upwards or downwards with respect to the shift dial; and
a sub PCB coupled to the shift dial and outputting a gear stage signal, which is generated when the shift button is operated, to the transmission control device.

2. The shift control apparatus of claim 1, further including an elastic pad disposed on the sub PCB and having a contact point contactable with the shift button on the contact point,
wherein, when the shift button is operated and the contact point of the elastic pad comes in contact with the sub PCB, the sub PCB outputs the gear stage signal to the transmission control device.

3. The shift control apparatus of claim 2, wherein the sub PCB outputs a P-stage signal of the gear stage signal to the transmission control device when the shift button is pressed and the contact point of the elastic pad comes in contact with the sub PCB, and
the main PCB outputs a gear stage signal for one of an R-stage, an N-stage, and a D-stage to the transmission control device in accordance with a change in position of the permanent magnet when the shift dial is turned in the first direction or the second direction.

4. The shift control apparatus of claim 2, wherein the shift dial includes:
a knob housing rotatably combined with the main housing to turn in the first direction or the second direction and having the permanent magnet opposite to the main PCB with respect to the main housing; and
a dial knob fixed with the knob housing to turn together.

5. The shift control apparatus of claim 1, further including a detent combined with the main housing and the shift dial in contact with each other to click when the shift dial is turned.

6. The shift control apparatus of claim 5, wherein the detent includes:
a detent boss disposed at the knob housing of the shift dial;
a detent pin slidably combined with the detent boss to selectively protrude in a radial direction of the shift dial;
a detent block fixed to the main housing, being in contact with an end portion of the detent pin, and having a grooved portion for contacting with the end portion of the detent pin; and
a spring elastically supporting the detent pin to keep the front end portion of the detent pin in contact with the grooved portion.

7. The shift control apparatus of claim 6,
wherein the grooved portion is formed in a shape in which ridges and grooves are continuously connected,
wherein a first groove and a second groove having a same depth are formed respectively at a first side and a second side of a middle ridge of the ridges at a center of the grooved portion,
wherein the first groove and the second groove are connected to a first ridge and a second ridge through a first slope and a second slope, respectively, and
wherein a peak of the middle ridge is disposed between the first slope and the second slope.

8. The shift control apparatus of claim 7, wherein an R-stage point is disposed on the first slope,
a D-stage point is disposed on the second slope,
an Nr-stage point and an Nd-stage point are disposed at the first groove and the second groove, respectively, and
the Nr-stage point and the Nd-stage point are all null stages and N-stages.

9. The shift control apparatus of claim 8, wherein, when the detent pin is moved from the Nr-stage point to the Nd-stage point with a R-stage currently selected, the main PCB outputs an N-stage signal as a final gear stage signal,
when the detent pin is moved from the Nr-stage point to the Nd-stage point and is further moved to the Nr-stage point with the R-stage currently selected, the main PCB outputs an R-stage signal as the final gear stage signal, and
when the detent pin is moved to the R-stage point or moved to the Nr-stage point over the R-stage point with the R-stage currently selected, the main PCB outputs the R-stage signal as the final gear stage signal.

10. The shift control apparatus of claim 8, wherein, when the detent pin is moved from the Nd-stage point to the Nr-stage point with the N-stage currently selected, the main PCB outputs an R-stage signal as a final gear stage signal,
when the detent pin is moved from the Nr-stage point to the Nd-stage point with the N-stage currently selected, the main PCB outputs a D-stage signal as the final gear stage signal,
when the detent pin is moved from the Nr-stage point to the R-stage point with the N-stage currently selected, the main PCB outputs the R-stage signal as the final gear stage signal,
when the detent pin is moved from the Nd-stage point to the D-stage point with the N-stage currently selected, the main PCB outputs the D-stage signal as the final gear stage signal, and
when the detent pin is not moved and the shift button is pressed with the N-stage currently selected, the main PCB outputs a P-stage signal as the final gear stage signal.

11. The shift control apparatus of claim 8, wherein, when the detent pin is moved from the Nd-stage point to the Nr-stage point with a D-stage currently selected, the main PCB outputs an N-stage signal as a final gear stage signal,
when the detent pin is moved from the Nd-stage point to the Nr-stage point and is further moved to the Nd-stage point with the D-stage currently selected, the main PCB outputs a D-stage signal as the final gear stage signal, and
when the detent pin is moved to the D-stage point or moved to the Nd-stage point over the D-stage point with the D-stage currently selected, the main PCB outputs the D-stage signal as the final gear stage signal.

12. The shift control apparatus of claim 8, wherein, when the detent pin is moved from the Nr-stage point to the Nd-stage point with a P-stage currently selected, the main PCB outputs a D-stage signal as a final gear stage signal, and
when the detent pin is moved from the Nd-stage point to the Nr-stage point with the P-stage currently selected, the main PCB outputs an R-stage signal as the final gear stage signal.

13. The shift control apparatus of claim 5, wherein the detent includes:
a detent boss disposed on the main housing;
a detent pin slidably combined with the detent boss to be configured to protrude toward the shift dial;
a gear plate combined with the shift dial to rotate together and having teeth formed on an external edge portion of the gear plate in contact with the end portion of the detent pin; and
a spring elastically supporting the detent pin to keep the end portion of the detent pin in contact with the teeth.

14. The shift control apparatus of claim 13,
wherein, when the shift dial is turned one click in the first direction with an R-stage currently selected, the main PCB outputs an N-stage signal as a final gear stage signal,
wherein, when the shift dial is turned at least two clicks in the first direction with the R-stage currently selected, the main PCB outputs a D-stage signal as the final gear stage signal, and
wherein, when the shift dial is turned one or more clicks in the second direction with the R-stage currently selected, the main PCB outputs an R-stage signal as the final gear stage signal.

15. The shift control apparatus of claim 13, wherein, when the shift dial is turned one or more clicks in the first direction with an N-stage currently selected, the main PCB outputs a D-stage signal as a final gear stage signal,
when the shift dial is turned one or more clicks in the second direction with the N-stage currently selected, the main PCB outputs an R-stage signal as the final gear stage signal, and
when the shift dial is not turned and the shift button is pressed with the N-stage currently selected, the main PCB outputs a P-stage signal as the final gear stage signal.

16. The shift control apparatus of claim 13, wherein, when the shift dial is turned one click in the second direction with a D-stage currently selected, the main PCB outputs an N-stage signal as a final gear stage signal,
when the shift dial is turned at least two clicks in the second direction with the D-stage currently selected, the main PCB outputs an R-stage signal as the final gear stage signal, and
when the shift dial is turned one or more clicks in the first direction with the D-stage currently selected, the main PCB outputs a D-stage signal as the final gear stage signal.

17. The shift control apparatus of claim 13, wherein, when the shift dial is turned one click in the first direction or the second direction with a P-stage currently selected, the main PCB outputs an N-stage signal as a final gear stage signal,
when the shift dial is turned at least two clicks in the first direction with the P-stage currently selected, the main PCB outputs a D-stage signal as the final gear stage signal, and
when the shift dial is turned at least two clicks in the second direction with the P-stage currently selected, the main PCB outputs an R-stage signal as the final gear stage signal.

18. A shift control apparatus for an electronic shift system, wherein a P-stage is selected by pressing a shift button,
one of an R-stage, an N-stage, and a D-stage is selected by turning a shift dial,
the R-stage is disposed at a first end portion of the shift dial in a first direction, the D-stage is disposed at a second end portion in a second direction, and a null-stage is disposed between the R-stage and the D-stage, when the shift dial is turned,
the shift dial is self-returned to the null-stage by a spring force when the shift dial is turned from the null-stage to the R-stage and then released, and
the shift dial is self-returned to the null-stage by the spring force when the shift dial is turned from the null-stage to the D-stage and then released.

19. The shift control apparatus of claim 18, wherein the null-stage is divided into an Nr-stage and an Nd-stage, and
the Nr-stage is disposed at a side of the R-stage, the Nd-stage is disposed at a side of the Nr-stage, and the D-stage is disposed at a side of the Nd-stage, when the shift dial is turned from the R-stage to the D-stage.

20. The shift control apparatus of claim 18, wherein the shift dial is self-returned to an Nr-stage by a spring force when the shift dial is turned from the Nr-stage to the R-stage and then released, and
the shift dial is self-returned to an Nd-stage by the spring force when the shift dial is turned from the Nd-stage to the D-stage and then released.
